(19) United States
(12) Patent Application Publication
(10) Pub. No.: US 2016/0035446 A1
(43) Pub. Date: Feb. 4, 2016

(54) Novel Vertical Concrete Cask Design Used for Storing Nuclear Spent Fuel Dry Storage Canister

(71) Applicant: Institute of Nuclear Energy Research, Atomic Energy Council, Executive Yuan, R.O.C., Taoyuan County (TW)

(72) Inventors: Kuei-Jen Cheng, Taoyuan County (TW); Yu-Tang Yang, Taoyuan County (TW); Hsueh-Yuan Lee, Taoyuan County (TW)

(21) Appl. No.: 14/448,225

(22) Filed: Jul. 31, 2014

(51) Int. Cl. G21F 5/008; G21F 5/12; G21F 5/10

(52) U.S. Cl. CPC G21F 5/008; G21F 5/10; G21F 5/12

(57) ABSTRACT

A concrete cask is used for storing a nuclear spent fuel dry storage canister. The cask has a shape of a vertical cylinder and is able to isolate the stored nuclear spent fuel dry storage canister from the ambient environment and shield the radiation from the stored nuclear spent fuels. An insulating ring is used for improving the dissipation and the transference uniformity of decay heat generated from the stored nuclear spent fuels. The insulating ring thus prevents the temperature of the concrete wall adjacent to the canister from exceeding specified limit. An Air inlet and an air outlet are used to generate a natural convection for moving out the decay heat. Therein, the vertical concrete cask is prevented from being overheated. Thus, the present invention improves the storage safety of a dry storage system.

### FIELD OF THE INVENTION

The present invention relates to storing a loaded nuclear spent fuel dry storage canister; more particularly, relates to, by means of an insulating ring, uniformly transferring decay heat of stored nuclear spent fuels to a concrete wall to prevent the local temperature of the concrete wall from exceeding the specified limit, where storage safety of a dry storage system is thus enhanced.

### BACKGROUND OF THE INVENTION

A dry storage system mainly consists of a nuclear spent fuel dry storage canister and a cask, where the cask is usually a vertical concrete cask. The nuclear spent fuel dry storage canister is mainly used for maintaining a sub-critical state of stored nuclear spent fuels, preventing leakage of stored radioactive materials, and isolating stored nuclear spent fuels from the ambient environment. Because the stored nuclear spent fuels would continuously generate radiation and heat due to decay, the concrete cask is used for shielding the radiation and dissipating the heat. Hence, the nuclear spent fuel dry storage canister can be stored in the concrete cask safely.

In general, a common vertical concrete cask has a steel liner and a concrete wall. Under considerations of shielding capacity, dimensions, weight and impact resistance, the gap between the nuclear spent fuel dry storage canister and the vertical concrete cask must be in certain limits. Consequently, the temperature of the inner concrete wall may exceed the specified limit, and the properties and performance of the concrete would deteriorate. This will degrade the storage safety of a dry storage system.

Hence, the prior arts do not fulfill all users' requests on actual use.

### SUMMARY OF THE INVENTION

The main purpose of the present invention is to use an insulating ring for enhancing heat dissipation capacity and uniformly transfer the decay heat to prevent the temperature of the adjacent concrete wall from exceeding the specified limit, where the shielding capacity, dimensions, weight and impact resistance of the cask are not changed but with better storage safety by keeping the temperature of the concrete wall within a safe range.

To achieve the above purpose, the present invention is a vertical concrete cask used for storing a loaded nuclear spent fuel dry storage canister, comprising a lid, a steel liner, a concrete wall, an air outlet, an air inlet, an insulating ring and a bottom weldment, where the steel liner comprises a cylindrical steel liner, an upper triangular rib plate and a rectangular rib; the upper triangular rib secures the insulating ring onto the steel liner and guides a nuclear spent fuel dry storage canister into the vertical concrete cask; the air inlet and air outlet facilitate the occurrence of the natural convection to move out the decay heat from the dry storage system; and the insulating ring is set on the steel liner to improve the dissipation of the decay heat generated by nuclear spent fuel and uniformly transfer it. Accordingly, a novel vertical concrete cask for storing a loaded nuclear spent fuel dry storage canister is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the perspective cross-sectional view showing the preferred embodiment according to the present invention; and

FIG. 2 is the enlarged partial cross-sectional view.

### DESCRIPTION OF THE PREFERRED EMBODIMENT

The following description of the preferred embodiment is provided to understand the features and the structures of the present invention.

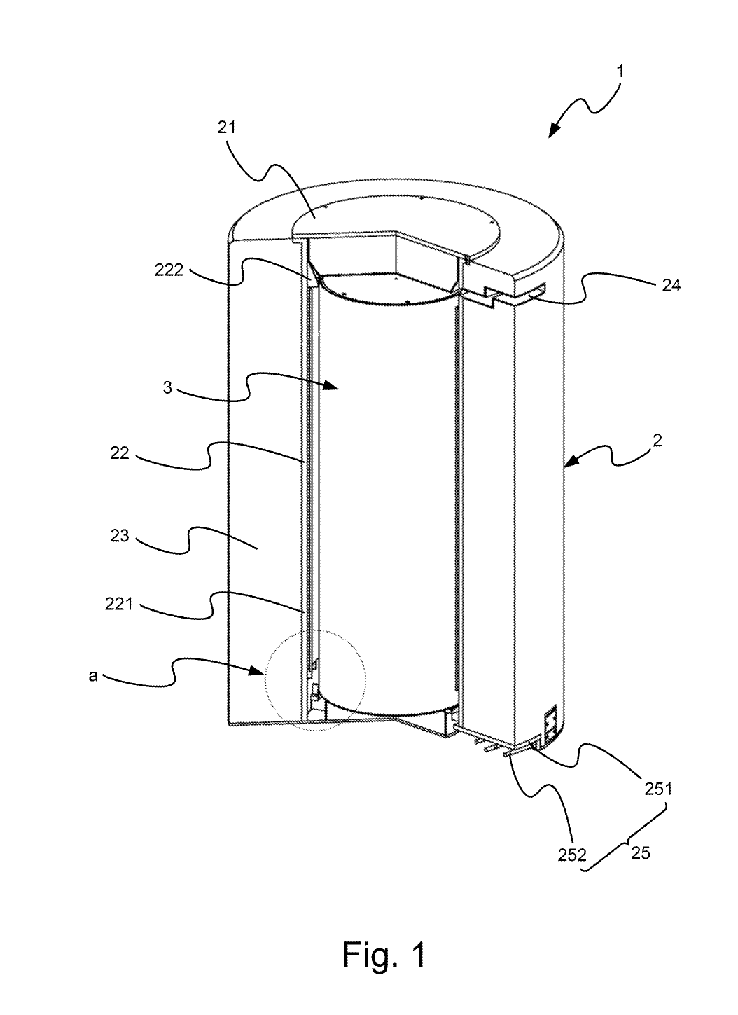

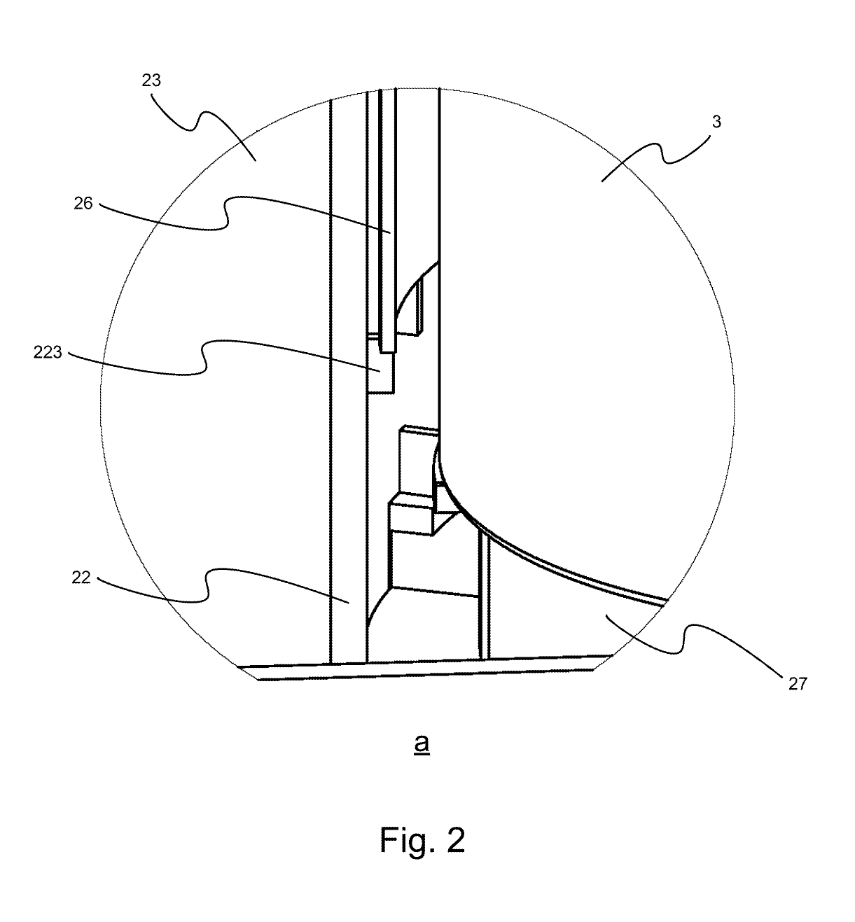

Please refer to FIG. 1 and FIG. 2, which are a perspective cross-sectional view and an enlarged partial cross-sectional view showing a preferred embodiment according to the present invention. As shown in the figures, a dry storage system 1 comprises the present invention 2 and a canister 3, where the canister is a nuclear spent fuel dry storage canister and the present invention is an vertical concrete cask 2 for storing the canister 3. Hence, the present invention is a vertical concrete cask for storing a nuclear spent fuel dry storage canister, where the cooling capacity is improved; decay heat uniformly transfers from the canister to the steel liner; and the temperature of the adjacent concrete wall to the canister 3 is utterly in the specified range. The vertical concrete cask 2 comprises a lid 21, a steel liner 22, a concrete wall 23, an air outlet 24, an air inlet 25, an insulating ring 26 and a bottom weldment 27. Therein, the steel liner 22 comprises a cylindrical steel liner 221, an upper triangular rib 222 and a rectangular rib 223; and, the air inlet 25 comprises an inlet frame 251, and a shield bar 252.

The lid 21 is installed on top of the vertical concrete cask 2 for protecting the canister 3 from the adverse influence caused by surrounding environment and providing the functions of shielding and heat dissipation. The steel liner 22 is the carriage of the insulating ring 26 with functions of shielding and heat conduction. The upper triangular rib 222 and the rectangular rib 223 secure the insulating ring 26 onto the cylindrical steel liner 221. The upper triangular rib 222 also has the function of guiding the canister 3 into the vertical concrete cask 2. The shape of the upper triangular rib 222 can be a plate, a cone, or a mixture of the above, where the cone can be a porous surface, a continuous surface, a sectioned surface or a mixture of at least two of the above surfaces. The concrete wall 23 is the main structure of the vertical concrete cask 2 for protecting the stored nuclear spent fuels during transportation, heat dissipation and shielding. The air outlet 24 guides hot air to leave the vertical concrete cask 2, where a tortuous path of the air flow is formed for reducing a radiation dose outside the vertical concrete cask 2. The air inlet 25 guides cold air to enter the vertical concrete cask 2, where a natural convection is formed with coordination of the air outlet 24 and the gap between the canister 3 and the concrete cask 2 to move the decay heat out of the dry storage system 1, and the inlet frame 251 is used for forming an inlet passage. The shield bar 252 shields the radiation emits through the air inlet 25. The insulation ring 26 enhances cooling capacity, uniformly transfers the decay heat, and shields radiation from the stored nuclear spent fuels. The insulating ring 26 can be a cylindrical steel insulating ring, an insulating ring with fins, or a fin module whose shape resembles to a ring. The bottom weldment 27 has functions of shielding, bearing the canister 3, and maintaining airway shape of the air inlet 25.

Thus, a novel vertical concrete cask for storing a loaded nuclear spent fuel dry storage canister is obtained.

When implementing the present invention, the canister 3 is put on the bottom weldment 27. Meanwhile, the lid 21 is mounted on top of the vertical concrete cask 2. Because nuclear spent fuels stored in canister 3 would decay and generate a great amount of heat, the temperature of the surface of the canister 3 will increase, and the air around of it will be heated up. Consequently, a natural convection is formed, where the heated air in the vertical concrete cask 2 moves upwardly and out of the dry storage system 1 through the air outlet 24; and cool air outside the dry storage system 1 enters into the vertical concrete cask 2 through the air inlet 25. The natural convection occurs in a natural-convection channel formed by the vertical concrete cask 2 and the canister 3 and coordinates with the air outlet 24 and the air inlet 25 to move the decay heat out of the dry storage system 1 to prevent the stored nuclear spent fuels and the dry storage system 1 from overheated and ensure the integrity of the stored nuclear spent fuels and the dry storage canister 3. Thus, the storage safety of the dry storage system 1 is further maintained.

In the natural-convection channel formed by the vertical concrete cask 2 and the canister 3, the insulation ring 26 is installed on the steel liner 22 of the vertical concrete cask 2 to prevent local concrete wall 23 from being overheated by the decay heat emitted from the canister 3. In the present invention, the insulating ring 26 promotes heat dissipation capacity in the natural-convection channel, and uniforms temperature distribution. Thus, the heat transmitted to the inner wall of the vertical concrete cask 2 through the steel liner 22 is lower and uniformly distributed. Further, the local temperature of the concrete wall 23 decreases significantly, and this prevents the concrete wall 23 from being overheated. Likewise, the insulation ring 26 also has the shielding function.

The upper triangular rib 222 not only fixes the insulation ring 26 to the steel liner 22, but also guides the canister 3 into the vertical concrete cask 2.

To sum up, the present invention is a vertical concrete cask for storing a nuclear spent fuel dry storage canister, where the nuclear spent fuel dry storage canister is protected; the radiation generated from the stored nuclear spent fuels is shielded; the heat generated owing to the decay of the nuclear spent fuel is dissipated; and, thus, the concrete wall of the vertical concrete cask is effectively prevented from being overheated for ensuring nuclear spent fuel storage safety.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A vertical concrete cask for storing a nuclear spent fuel dry storage canister of, comprising:
a lid;
a steel liner, said steel liner comprising a cylindrical steel liner, an upper triangular rib and a rectangular rib;
a concrete wall;
an air outlet;
an air inlet;
an insulating ring; and
a bottom weldment,
wherein said upper triangular rib secures said insulating ring onto said steel liner; and guides a nuclear spent fuel dry storage canister into the vertical concrete cask;
wherein said air inlet and air outlet faciliate a natural convection to move out decay heat generated by said nuclear spent fuels; and
wherein said insulating ring is located on said steel liner to improve dissipation of said decay heat generated by said nuclear spent fuels and uniformly transfer said decay heat.

2. The vertical concrete cask according to claim 1,
wherein said insulating ring is selected from a group consisting of a cylindrical insulating ring; an insulating ring with fins; and a fin module whose shape resembles to a ring.

3. The vertical concrete cask according to claim 1,
wherein said upper triangular rib has a surface selected from a group consisting of a plate, a cone, or a mixture of the above, where the cone can be with a porous surface, a continuous surface, a sectioned surface or a mixture of at least two of the above surfaces.

4. The vertical concrete cask according to claim 3,
wherein said cone surface is selected from a group consisting of a porous surface, a continuous surface, a sectioned surface and a mixture of at least two of the above surfaces.
